(19) United States
(12) Patent Application Publication
(10) Pub. No.: US 2008/0190940 A1
(43) Pub. Date: Aug. 14, 2008

(54) INSULATED CONTAINER

(76) Inventor: Peter Henry Scott, Queensland (AU)

Correspondence Address: HAMMER & ASSOCIATES, P.C., 3125 SPRINGBANK LANE, SUITE G, CHARLOTTE, NC, 28226, US

(21) Appl. No.: 12/029,805

(22) Filed: Feb. 12, 2008

(30) Foreign Application Priority Data
Feb. 13, 2007 (AU) 2007900724

(51) Int. Cl. B65D 81/38; B65D 25/00; B62B 1/00

(52) U.S. Cl. 220/592.2; 220/531; 280/29

(57) ABSTRACT

An insulated container including a main compartment having a bottom and a plurality of walls extending upwardly from the bottom to define an interior space, at least one storage compartment which is accessible through a side wall when the lid is closed, the at least one storage compartment moveable between an open condition in which the compartment is at least partially outside the main compartment and a closed condition in which the at least one storage compartment is wholly within the main compartment, the at least one storage compartment also accessible through the lid when open, wherein the volume of the at least one storage compartment is approximately the same as the volume of the main compartment.

### FIELD OF THE INVENTION

The present invention relates to insulated containers such as Eskys™, portable ice chests, cooler boxes or “chilly bins” and particularly to improvements thereto adding functionality and ease of use.

### BACKGROUND ART

Insulated containers of Eskys are available. The Esky has developed from a cumbersome weighty construct having a steel outside shell with cork insulation, to a two-layer plastic construction: Polypropylene on the outer shell, with a polyurethane inner layer. This makes it lightweight and portable with great insulation.

Insulated coolers became increasingly useful by the relatively recent advent of the use of rigid foam plastic for insulation purposes. These coolers typically are of rigid foamed polystyrene, and consist of a body, a lid and carrying handles applied to the body portion. Handles of the rigid foam cannot be made because the foam has insufficient strength. Further, the foam, while rigid, is soft and crumbles relatively easily in normal use.

More recently, coolers have employed a double-wall construction of a blow-molded plastic in which insulation is placed. The insulation may be foamed in place and typically is of urethane composition. The outer plastic shell may be a polyolefin, such as polystyrene, polyethylene, polypropylene, an ABS resin or any other suitable type. Coolers of this construction are of better quality than the non-sheathed rigid foam type, but are considerably more expensive and difficult to construct.

Known prior art includes U.S. Pat. No. 3,572,054; U.S. Pat. No. 5,524,761; U.S. Pat. No. 3,979,007, U.S. Pat. No. 3,791,547; U.S. Pat. No. 2,663,391; and U.S. Pat. No. Des. 309,239.

Insulated coolers of the types described above have been used for other purposes in addition to the storage of foods and beverages. The coolers are often used as seats when other, more suitable seating is unavailable. Using a cooler as seating creates a problem in that when someone needs to access the cooler, the person sitting on the cooler must stand to allow the lid to be lifted. This creates an issue for the person sitting on the cooler.

It is also a drawback that the lid of the cooler is not manufactured as a seat. It lacks the proper support as well as being a hard surface which makes sitting in the lid for extended periods uncomfortable.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to an insulated container, which may at least partially overcome at least one of the abovementioned disadvantages or provide the consumer with a useful or commercial choice.

In one form, the invention resides in an insulated container including
a) a main compartment having a bottom and a plurality of walls extending upwardly from the bottom to define an interior space;
b) at least one storage compartment which is accessible through a side wall, the at least one storage compartment moveable between an open condition in which the compartment is at least partially outside the main compartment and a closed condition in which the at least one storage compartment is wholly within the main compartment, the at least one storage compartment also accessible through the lid when open, wherein the volume of the at least one storage compartment is approximately the same as the volume of the main compartment.

In a second form, the invention resides in an insulated container including
a) a main compartment having a bottom and a plurality of walls extending upwardly from the bottom to define an interior space;
b) at least one storage compartment which is accessible through a side wall, the at least one storage compartment pivotally moveable between an open condition in which the compartment is at least partially outside the main compartment and a closed condition in which the at least one storage compartment is wholly within the main compartment.

In a third form, the invention resides in an insulated container including
a) a main compartment having a bottom and a plurality of walls extending upwardly from the bottom to define an interior space;
b) at least one storage compartment which is accessible through a side wall, the at least one storage compartment moveable between an open condition in which the compartment is at least partially outside the main compartment and a closed condition in which the at least one storage compartment is wholly within the main compartment; and
c) at least one seat portion associated with the lid.

The insulated container of the present invention is particularly adapted to use as a container for storing foodstuffs. The container may be adapted for insulation of heated or cooled items but will mainly be used for cooled items, as an Esky®, cooler box or “chilly bin”.

Preferably, the container will have a rigid outer and inner shell to prevent damage with a space between the shells to contain insulation.

There may be one or more wheels or similar mechanisms mounted at such a location that if the container is angled, the wheels lift the container above the surface to allow the container to be easily moved. There will also typically be handle means provided on the container to allow the container to be pulled or dragged along on the wheels.

The container will also preferably be provided with a fluid drain plug to allow accumulated fluid from inside the container to be drained from the container. As well as the fluid drain plug, there may be a drink dispenser spigot provided to allow drinks to be stored inside the container and dispensed without opening the container lid or opening a storage compartment. The fluid drain plug could be used for this purpose but is preferably not a double use plug. There may be an opening provided in an exterior wall of a storage compartment through which drink dispensing nozzle may be inserted.

It is preferred that the container be substantially rectangular in cross-section. In this configuration, the container will preferably have a base wall and two end walls, openings in the (or open) sidewalls, a lid to close the opening at the top of the container and the storage compartments will close the openings in the sidewalls. There will normally therefore be a top opening and one or more sidewall openings.

The container preferably includes a main compartment having a bottom and a plurality of walls extending upwardly from the bottom to define an interior space, and a top opening. The main compartment will typically be defined by a combination of fixed and movable walls.

The main compartment is preferably defined by the inner surface of the base wall, end walls and the portions surrounding the openings in the sidewalls. The main compartment will typically be substantially rectangular in shape, but may have any shape. As such, the container will normally have a longitudinal dimension, typically the dimension having the sidewalls and a transverse direction, typically having the end walls.

Typically, the end walls of the container will be fixed walls which are continuous to close the end of the compartment. In contrast, the side walls of the compartment will normally include at least one opening for the storage compartments. There will normally be at least an opening in each sidewall and the opening will be defined by a surround frame incorporating sill members about the opening. The number of openings in each sidewall may be the same or different and will be chosen according to a preferred configuration for use. Different containers may have different numbers and combinations of storage compartments.

The top opening of the compartment/container is preferably defined by a surround frame formed from the upper edges of the end walls and the sill members of the sidewalls.

Typically, the sidewalls will have a centrally located opening defined by a lower sill member extending upwardly from the base wall of the container, a pair of side surround members extending from the respective end walls and from the lower sill member and an upper head member extending between the side surround members.

It is also anticipated that the openings to receive the storage compartments may be located in the end walls of the container and not the side walls or in combination with the sidewall compartments. So either the ends walls will normally be continuous or the sidewalls will be continuous but both may have openings. Each of the walls may include an opening defined by a surround frame except the basewall.

In the preferred form, the container will be manufactured without a top lid as conventional containers are, but with a fixed top wall. In contrast, the present invention container will typically be manufactured with a top and a base wall with end walls extending therebetween. Extension portions extending partially into the plane of a sidewall may be provided to define the openings for the storage compartments. Any one or more of the walls or extension portions may be reinforced to provide extra strength, particularly when the container is configured for use as a seat.

The present invention may also include a lid for covering said top opening of said main compartment. There may be more than one lid member. Construction of the lid member(s) will normally be similar to that of the wall members with a solid inner and outer wall and an insulative material juxtaposed between them. The lid member(s) will normally be associated with one or more hinge members and one or more latches or latch mechanisms may be provided to secure the lid member(s) in the closed condition.

The present invention also includes at least one storage compartment which is accessible through a side wall when the lid is closed, the at least one storage compartment moveable between an open condition is which the compartment is at least partially outside the main compartment and a closed condition is which the at least one storage compartment is wholly within the main compartment, the at least one storage compartment also accessible through the lid when open, wherein the volume of the at least one storage container is approximately the same as the volume of the main compartment.

The storage compartment(s) of the present invention will preferably each have a drawer or bin-like configuration. Each will typically have a storage volume defined by a base wall, a pair of opposed sidewalls, an external wall or face and an opposed internal back wall. The compartment may preferably have an open top but a separate lid for the storage compartment may be provided.

Preferably, the external wall or face of the storage compartment will form a part at least of a wall of the container when closed sealing the internal compartment when all of the storage compartments are closed. The external wall may therefore be configured similarly to that of the wall members with a solid inner and outer wall and an insulative material juxtaposed between them. The other walls of the storage department may be simple planar walls manufactured of plastic for example as they will not need to be insulated. It is possible that the other walls may be insulated walls but they will preferably will not be.

An outer surface of the external wall of the storage compartment will typically be provided with a handle for grip when opening and closing the compartment and the handle may be an integrally molded handle.

The external wall of the storage compartment will also preferably be at least as big as the opening defined in the wall of the container but will preferably be larger than the opening. One or more seal members will normally be provided to ensure that the container is as efficient as possible.

As stated above, there may be one or more storage compartment(s) provided in each wall.

Each storage compartment is preferably moveable between the open and closed condition in a pivotal as opposed to a sliding manner. According to a particularly preferred embodiment, each storage compartment will be provided with a fulcrum at a lower point and towards the outer side of the compartment. Preferably the fulcrum may be provided as a pair of lug members, one on either side wall at a lower outer corner of the sidewall of the compartment. In this manner, a handle provided towards an upper end of the exterior face of the compartment will allow the handle to be drawn outwardly and downwardly to open the compartment. This rotational opening may not result on the large loads that are created with a full storage compartment is slid open.

A pair of depressions or openings will typically be provided in the surround frame adjacent each storage compartment to correspond to the lugs, one on either side of the storage compartment. The openings may be provided in the fixed portion of the container such as the end walls but are preferably hi the surround frame members.

According to a particularly preferred embodiment, there will normally be a pair of storage compartments opening onto opposite sides of the container, each compartment approximately half the width of the container but preferably as high as the container. The sidewalls of the compartments may decrease in height towards the centre of the container to allow for the pivoting opening thereof. When closed, the inner walls of the compartments will preferably abut each other.

There will normally be one or more latches or catches associated with each storage compartment in order to retain the storage compartment securely in the closed condition, even will filled. At least a portion of the latch or catch will be located on the fixed walls of the container and engage a locking or latch member on the exterior wall of the storage compartment.

The container will also preferably be provided with a seat portion. The seat portion will typically include a shaped or cushioning portion associated with the lid of the container. A backrest portion may also be provided. The backrest portion is preferably moveable from a storage position to a use position in which it is located above and behind (from at least one side of) the shaped or cushioning portion.

Preferably, the backrest portion may be foldable or pivotable. It may fold into a storage position overlying the lid of the container for transport and when not in use. The pivotable backrest is normally attached to the edge of the lid or to an upper portion of a sidewall of the container. In this form, the backrest may be configured as a pair of spaced apart arm members with a backrest portion therebetween with a pivot means located at or towards a lower end of each arm member. Alternative configurations are also possible.

The backrest portion may be slideable. A housing or similar my be provided adjacent a side or end wall of the container into and out of which the backrest portion may be slid for use and transport. The backrest in this form, may be similar to the pivoting configuration but again alternative configurations are also possible.

The container in general may be provided with one or more lifting handles, preferably a pair. These lifting handles will normally be provided on fixed walls.

Any latches provided according to the invention will preferably be a type of overcentre lever latch which are commercially available. Preferably, a latch will be provided on each side of each storage compartment.

The storage compartments of the present invention will typically be configured to maximise the size of the storage compartments and therefore the useable space within the insulated container and to minimise the losses from the container and unused space within the container. A user may use the container as a seat at a function and still have access to the interior of the container without the need to stand to allow the top lid to be opened.

### BRIEF DESCRIPTION OF THE DRAWINGS

Various embodiments of the invention will be described with reference to the following drawings, in which:

FIG. 1 is a schematic end view with hidden detail of an insulated container according to a preferred embodiment of the present invention.

FIG. 2 is a schematic side view of the insulated container of FIG. 1.

FIG. 3 is a schematic top view of the container of FIG. 1.

FIG. 4 is a schematic view of the drawers included in the container of FIG. 1.

FIG. 5 is a schematic top view of a drawer according to a preferred embodiment of the present invention.

FIG. 6 is a schematic front view of the drawer illustrated in FIG. 5.

FIG. 7 is a side view of a chair portion included as part of the present invention according to a preferred embodiment.

FIG. 8 is a front view of a molded handle used according to a preferred embodiment.

FIG. 9 is a side view of the handle illustrated in FIG. 8.

FIG. 10 is a front view of a clip fastener used according to a preferred embodiment.

FIG. 11 is a front view of a drain used according to a preferred embodiment.

FIG. 12 is a front view of a handle used according to a preferred embodiment.

FIG. 13 is a side view of the handle illustrated in FIG. 12.

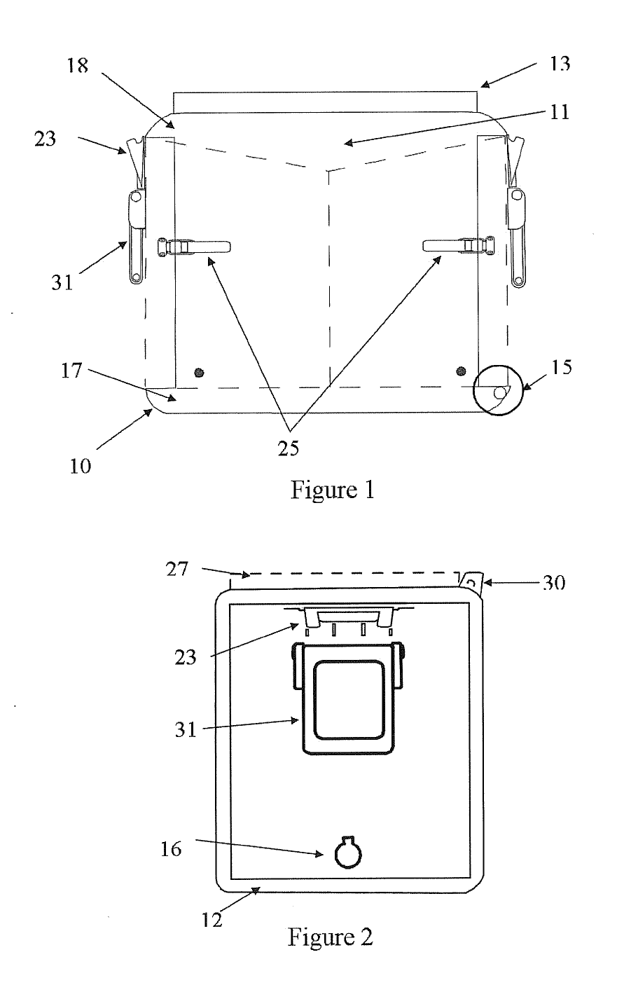

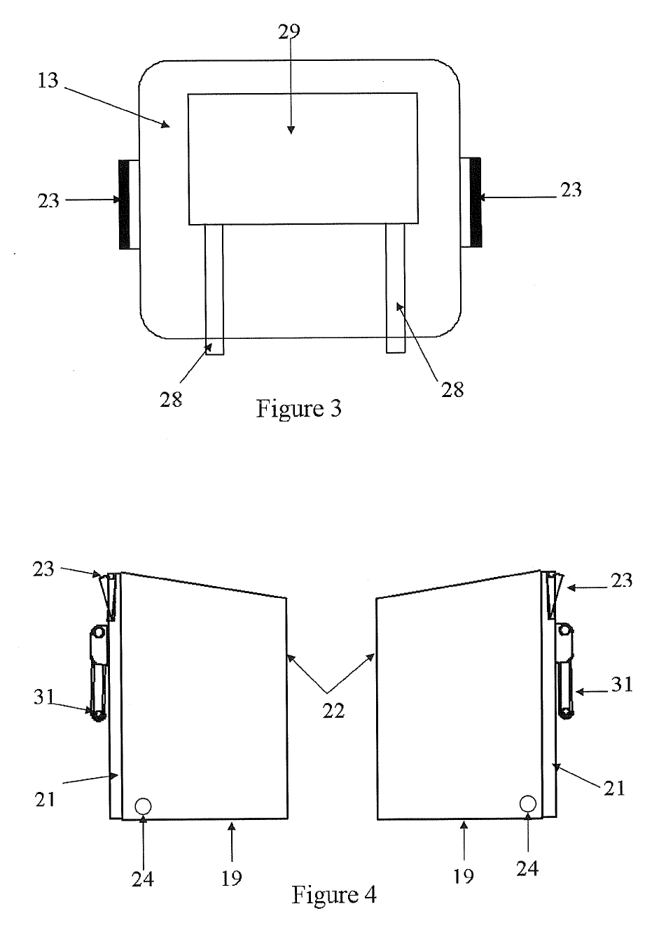

### DETAILED DESCRIPTION OF THE PREFERRED EMBODIMENT

According to an aspect of the present invention, an insulated container 10 is provided.

According to the embodiment illustrated in the Figures, the insulated container 10 includes a main compartment 11 having a bottom 12 and a plurality of walls extending upwardly from the bottom 12 to define an interior space and a top opening, a lid 13 for covering said top opening of said main compartment 11 and storage compartments 14 which are accessible through a side wall when the lid 13 is closed, the storage compartments 14 moveable between an open condition in which the compartments 14 are at least partially outside the main compartment 11 and a closed condition in which the storage compartments 14 are wholly within the main compartment 11, the storage compartments 14 also accessible through the lid 13 when open, wherein the volume of the storage compartments 14 is approximately the same as the volume of the main compartment 11.

The insulated container 10 of the present invention is particularly adapted to use as a container for storing foodstuffs. The storage compartments 14 of the embodiment are configured to maximise the size of the storage compartments 14 and therefore the useable space within the insulated container 10 and to minimise the losses from the container 10 and unused space within the container. A user may additionally use the container as a seat at a function and still have access to the interior of the container 10 without the need to stand to allow the top lid 13 to be opened.

The container has a rigid outer and inner shell to prevent damage with a space between the shells to contain insulation.

There are wheels 15 mounted adjacent a corner of the container 10 such that if the container is angled, the wheels 15 lift the container 15 above the surface to allow the container 10 to be easily moved. There are handle means provided on the container to allow the container to be pulled or dragged along on the wheels 15.

The container has a fluid drain plug 16 and illustrated in FIG. 11, to allow accumulated fluid from inside the container 10 to be drained from the container, normally melted ice or similar.

The illustrated container is substantially rectangular in cross-section. The container 10 includes a main compartment 11 having a bottom 12 and a plurality of walls extending upwardly from the bottom 11 to define an interior space and a top opening. The main compartment 11 is defined by a combination of fixed and movable walls.

The main compartment is defined by the inner surface of the base wall 12, end or side walls and portions surrounding the openings in the end or sidewalls.

There is an opening in each of two opposed sidewalls and the opening is defined by a surround frame incorporating sill members about the opening. Typically, the sidewalls will have a centrally located opening defined by a lower sill member 17 extending upwardly from the base wall of the container, a pair of side surround members extending from the respective end wall and from the lower sill member 17 and an upper head member 18 extending between the side surround members.

The illustrated container 10 also includes a lid 13 for covering the top opening of the main compartment. Construction of the lid member(s) will normally be similar to that of the wall members with a solid inner and outer wall and an insulative material juxtaposed between them. The lid member(s) will normally be associated with one or more hinge members (not shown) and one or more latches or latch mechanisms (not shown) to secure the lid member(s) in the closed condition.

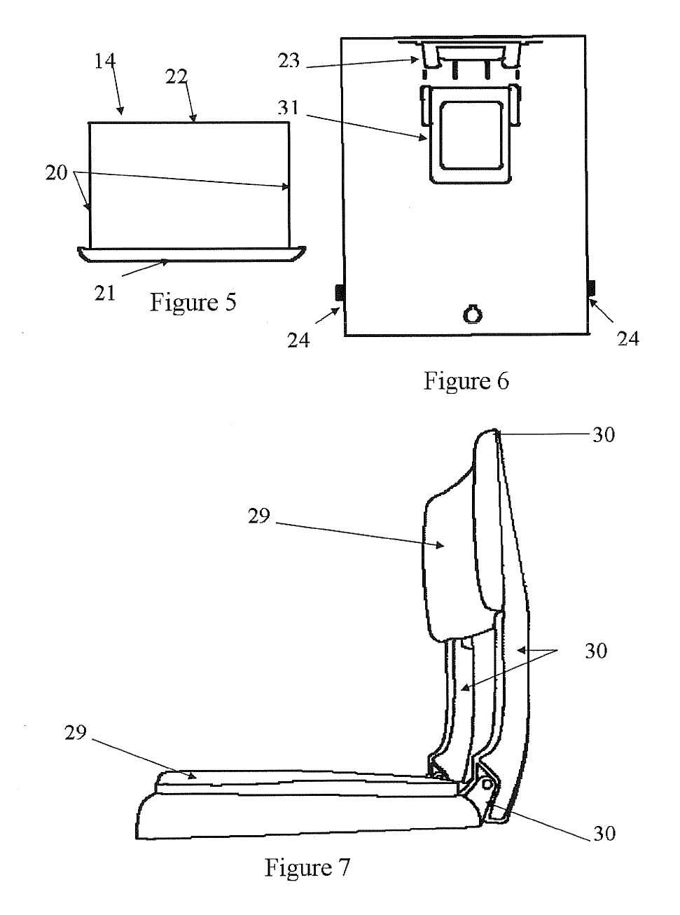

The storage compartment(s) 14 of the present invention, illustrated particularly in FIGS. 4 to 6 each have a drawer or bin-like configuration. Each has a storage volume defined by a base wall 19, a pair of opposed sidewalls 20, an external wall or face 21 and an opposed internal back wall 22.

The external wall or face 21 of the storage compartment forms a part of a wall of the container 10 when closed, sealing the internal compartment when all of the storage compartments 14 are closed. The external wall 21 of each compartment 14 is configured similarly to that of the wall members with a solid inner and outer wall and an insulative material juxtaposed between them. The other walls of the storage department of the illustrated embodiment are simple planar walls manufactured of plastic for example as they will not need to be insulated.

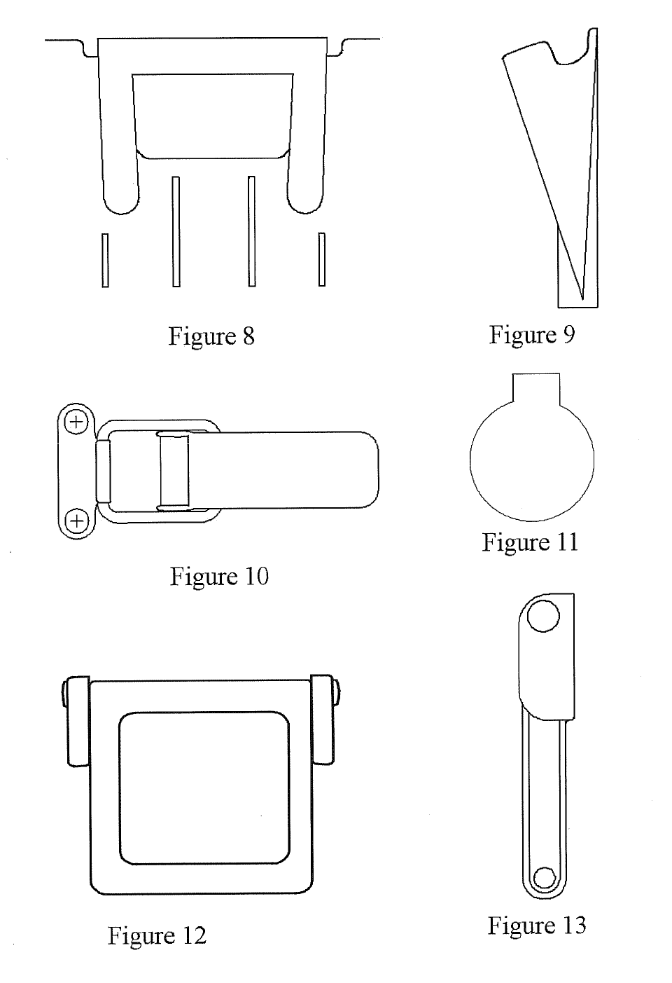

An outer surface of the external wall 21 of the storage compartment is provided with a molded handle 23 for grip when opening and closing the compartment, as illustrated in FIGS. 8 and 9.

The external wall 21 of the storage compartment of the illustrated embodiment is larger than the opening defined in the wall of the container 10.

Each storage compartment 14 is moveable between the open and closed condition in a pivotal manner. According to the illustrated embodiment, each storage compartment 14 is provided with a pair of lug members 24, one on either side wall 20 at a lower outer corner of the sidewall 20 of the compartment. In this manner, the handle 23 provided towards an upper end of the exterior face 21 of the compartment 14 allows the top of the compartment to be drawn outwardly and downwardly to open the compartment 14.

A pair of depressions or openings are typically provided in the surround frame adjacent each storage compartment 14 to correspond to the lugs, one on either side of the storage compartment. The openings are provided in the surround frame members.

According to the illustrated embodiment, there is a pair of storage compartments 14 opening onto opposite sides of the container 10, each compartment approximately half the width of the container but as high as the container 10. The sidewalls 20 of the compartments 14 decrease in height towards the centre of the container to allow for the pivoting opening thereof. When closed, the inner walls of the compartments will abut each other as illustrated in FIG. 1.

There are also latches 25, as illustrated in FIG. 10, associated with each storage compartment 14 in order to retain the storage compartment 14 securely in the closed condition, even when filled. At least a portion of the latch 25 is located on the fixed walls of the container and engage a locking or latch member on the exterior wall 21 of the storage compartment.

The container 10 is also provided with a seat portion as illustrated in FIG. 7. The seat portion includes a shaped or cushioning portion 26 associated with the lid 13 of the container 10. A backrest portion 27 is also provided. The backrest portion 27 is moveable from a storage position to a use position in which it is located above and behind the shaped or cushioning portion 26.

The backrest portion 27 of the illustrated embodiment is foldable or pivotable. It folds into a storage position overlying the lid 13 of the container for transport and when not in use. The pivotable backrest 27 is normally attached to the edge of the lid 13 or to an upper portion of a sidewall of the container. In this form, the backrest is configured as a pair of spaced apart arm members 28 with a backrest portion 29 therebetween with a pivot means 30 located at or towards a lower end of each arm member.

The container is also provided with lifting handles 31, preferably a pair as illustrated in FIGS. 12 and 13. These lifting handles will normally be provided on fixed walls.

In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. An insulated container including:
a. a main compartment having a bottom and a plurality of walls extending upwardly from the bottom to define an interior space;
b. at least one storage compartment which is accessible through a side wall, the at least one storage compartment pivotally moveable between an open condition in which the compartment is at least partially outside the main compartment and a closed condition in which the at least one storage compartment is wholly within the main compartment.

2. An insulated container according to claim 1 wherein the container has a rigid outer and inner shell to prevent damage, with a space between the inner and outer shell to contain insulation.

3. An insulated container according to claim 1 wherein one or more wheels are provided, mounted at such a location that when the container is angled, the wheels lift the container above the surface to allow the container to be easily moved.

4. An insulated container according to claim 1 wherein the container is substantially rectangular in cross-section with a base wall and two end walls, a top wall and openings in sidewalls, the storage compartments adapted to close the openings in the sidewalls.

5. An insulated container according to claim 1 wherein the container has an integrally formed base wall, two end walls, a top wall and openings in sidewalls with the storage compartments provided with external walls adapted to close the openings in the sidewalls.

6. An insulated container according to claim 1 further including at least one internal dividing wall to divide the interior space.

7. An insulated container according to claim 1 wherein the container has at least an opening in each sidewall and each opening is defined by a surround frame incorporating sill members about the opening.

8. An insulated container according to claim 5 wherein the container is manufactured without a top lid.

9. An insulated container according to claim 1 wherein the container includes an upper opening and a lid for covering the upper opening.

10. An insulated container according to claim 1 wherein each storage compartment has a drawer or bin-like configuration with an external wall, a base and a plurality of sidewalls.

11. An insulated container according to claim 10 wherein each storage compartment has an open top.

12. An insulated container according to claim 5 wherein the external wall of each storage compartment forms a part at least of a wall of the container when closed sealing the internal compartment when all of the storage compartments are closed.

13. An insulated container according to claim 5 wherein the external wall of each storage compartment is larger than the opening in the wall of the container to seal the internal compartment when closed.

14. An insulated container according to claim 10 wherein the external wall has a solid inner and outer wall and an insulative material juxtaposed between with the sidewalls and base uninsulated.

15. An insulated container according to claim 10 wherein each storage compartment is moveable between the open and closed condition in a pivotal manner.

16. An insulated container according to claim 15 wherein each storage compartment is provided with a fulcrum at a lower point and towards the outer side of the compartment about which the storage compartment can be rotated.

17. An insulated container according to claim 15 wherein at least one latch is associated with each storage compartment in order to retain the storage compartment securely in the closed condition.

18. An insulated container according to claim 5 further including a backrest portion moveable from a storage position to a use position in which it is located above the top wall.

19. An insulated container according to claim 18 wherein the backrest portion is attached to the top wall and has a pair of spaced apart arm members with a backrest portion therebetween, with a pivot means located at or towards a lower end of each arm member.

20. An insulated container including
a. a main compartment having a bottom and a plurality of walls extending upwardly from the bottom to define an interior space;
b. at least one storage compartment which is accessible through a side wall, the at least one storage compartment moveable between an open condition in which the compartment is at least partially outside the main compartment and a closed condition in which the at least one storage compartment is wholly within the main compartment; and
c. at least one seat portion associated with the lid.

21. An insulated container including:
a. a main compartment having a bottom and a plurality of walls extending upwardly from the bottom to define an interior space;
b. at least one storage compartment which is accessible through a side wall, the at least one storage compartment moveable between an open condition in which the compartment is at least partially outside the main compartment and a closed condition in which the at least one storage compartment is wholly within the main compartment, wherein the volume of the at least one storage compartment is approximately the same as the volume of the main compartment.
